(19) United States
(12) Patent Application Publication
(10) Pub. No.: US 2018/0312786 A1
(43) Pub. Date: Nov. 1, 2018

(54) NANO SUPER ION WATER AND PREPARATION METHOD OF THE SAME

(71) Applicant: KUNSHAN NANO NEW MATERIAL TECHNOLOGY CO.,LTD, Kunshan City (CN)

(72) Inventors: Hung-Tu LU, Taipei City (TW); Cheng-Wen LO, Kaohsiung City (TW); Tak-Ngai Samuel SI, Hong Kong (CN); Ming-Yan TAI, Hong Kong (CN)

(21) Appl. No.: 15/704,427

(22) Filed: Sep. 14, 2017

(30) Foreign Application Priority Data
Apr. 26, 2017 (TW) 106113942

(51) Int. Cl. C11D 7/06; C02F 1/461; C25B 1/10; C25B 9/10; A01N 59/00

(52) U.S. Cl. CPC C11D 7/06; C02F 1/4618; C25B 1/10; C02F 2103/02; A01N 59/00; C02F 2001/4619; C25B 9/10

(57) ABSTRACT

Nano super ion water and a preparation method of the same are provided, wherein the method including the following steps: adjusting a distance between two electrode plates of a electrolysis device to a predetermined distance, adding pre-electrolysis water to a cathode electrode, adding a carbonate solution to an anode electrode, applying an electrolysis reaction to the pre-electrolysis water and the carbonate solution separated by an ion-exchange membrane, and collecting the nano super ion water from the anode electrolysis tank. The nano super ion water of the present invention provides better detergency for removing dirt and chemical residues, and also provides functions of odor elimination, disinfection, and resistance of corrosive oxidation of an object.

### CROSS-REFFERENCE TO RELATED APPLICATION

This application claims priority from Taiwan Patent Application No. 106113942, filed on Apr. 26^{th}, 2017 at Taiwan Intellectual Property Office, the contents of which are hereby incorporated by reference in their entirety for all purposes.

### BACKGROUND OF THE INVENTION

### 1. Field of the Invention

The present invention refers to a preparation method of nano super ion water and the ion water prepared via the method. In particular, the present invention provides a method of preparing small cluster nano super ion water via electrolysis and the small cluster nano super ion water obtained via the electrolysis method.

### 2. Description of the Related Art

Water (H₂O), which is a colorless and tasteless transparent liquid at a normal temperature and normal pressure condition, and an inorganic compound consists of two hydrogen atoms and an oxygen atom. Common water, such as river water, well water or tap water do not exist in a form of a single water molecule, but in a form of a molecule cluster which is assembled by an interaction between the hydrogen bonds of a plurality of water molecules. The cluster is also called a “water molecule cluster”.

Since it is believed that water having smaller water molecule clusters provides better permeability and easier to enter smaller gaps in order to wash out the remains that are hard to be removed, and therefore having higher detergency in comparison with normal water which has large water molecule clusters. However, most of the water molecule clusters found in nature are consisted of more than 10 water molecules. Hence, water having small water molecule clusters needs to be prepared by a physical or chemical methods.

Theoretically, the hydrogen bonds between water molecules significantly influence the size of water molecule clusters, and heating, boiling or vaporizing water gives water molecules larger kinetic energy, which keep the water molecules from restraint of hydrogen bonds so that the water having smaller water molecule clusters may be formed. However, when cooled down to room temperature, the water molecule clusters may reassemble back to larger water molecule clusters, thus they are not ideal methods for preparing the water having small water molecule clusters. Hence, in recent years, the water having small water molecule clusters are usually prepared by physical impact, magnetic field effect or electrolysis methods. Among these methods, the physical impact method may cause the obtained water to have ununiformed sizes of molecule clusters, and the apparatus thereof is easily deteriorated; in the magnetic field effect method, various additives should be added into the water to stabilize water molecule clusters (e.g. US Patent No. 20110218251A), thus the water is not pure water and the impurities may remain on the washed objects causing adverse effects; and the water having small water molecule clusters obtained by the electrolysis method may have a better stability, and the apparatus thereof may not be easily deteriorated. However, the separation of the by-products mixed therein during the process is still a problem to be solved (e.g. CN Patent No. 105439252A).

On the other hand, besides water having small water molecule clusters, alkaline ionized water is also believed to have higher detergency, disinfection ability and other functions. In general, ionized water is obtained by an electrolysis method based on redox principles. In the processes of electrolysis, alkaline ionized water is generated at cathode, and acidic ionized water is generated at anode, wherein the alkaline ionized water is also used in the fields of drinking, health care and cleaning. The alkaline ionized water obtained by the electrolysis method usually use sodium chloride as a raw material for electrolysis. Hence, the generated alkaline ionized water generally contains chloride. However, when cleaning a metal-made product, chloride may cause the product to corrode (rust) easily, thus the usage is still limited in industrial applications. Furthermore, most of the water obtained from nature being neutral water or acidic water caused by acid rain from pollution. These may damage foods such as vegetables, and may cause deterioration and reduce the life expectancy of metal or wood made products and clothing during washing. Hence, these water are not well-suited for cleaning purposes.

Therefore, in order to provide ionized water having better detergency, disinfection ability and preventing washed objects from being corroded, there is still a need for an ideal method for preparing stable alkaline ionized water having small water molecule clusters without chloride for cleaning and disinfection purposes.

### SUMMARY OF THE INVENTION

To overcome the problems mentioned above in prior arts, the object of the present invention is to provide novel nano super ion water and the preparation method thereof.

According to an object of the present invention, a method of manufacturing a nano super ion water is provided, comprising: adjusting a distance of two electrodes of an electrolysis device to a predetermined distance; adding pre-electrolysis water into an anode electrolysis tank; adding a carbonate solution into a cathode electrolysis tank; applying an electrolysis reaction to the pre-electrolysis water and the carbonate solution separated by an ion-exchange membrane; and collecting the nano super ion water from the anode electrolysis tank.

Preferably, the predetermined distance is from 0.1 cm to 0.8 cm.

Preferably, a voltage used in the electrolysis reaction is from 8 V to 15 V.

Preferably, the ion-exchange membrane has a pore size between 0.001 μm to 0.005 μm.

Preferably, the method further comprises extracting a gas product using a gas extraction device during the electrolysis reaction.

According to another object of the present invention, a nano super ion water, which is manufactured by above method is provided.

Preferably, the pH value of the nano super ion water is from 8 to 14.

Preferably, the nano super ion water is a solution comprising 0.001% to 1.000% (w/w) of an alkali metal hydroxide.

Preferably, the nano super ion water comprises a water molecule cluster assembled by 4 to 13 water molecules.

Preferably, a half-width value of the nano super ion water measured by ¹⁷O-NMR is about 45 Hz to 70 Hz.

### BRIEF DESCRIPTION OF THE DRAWINGS

The technical features of the present invention will be described depending on the analysis results in the appending drawings of the present invention, which are provided as exemplary embodiments for a person skilled in the art to more easily understand the present invention and are not intended to limit the present invention in any way.

FIG. 1 is a ¹⁷O-NMR spectrum of the example PW-25 prepared in an embodiment of the present invention measuring in one day after prepared.

FIG. 2 is a ¹⁷O-NMR spectrum of the example PW-25 prepared in an embodiment of the present invention measuring after three months after prepared.

FIG. 3 is a ¹⁷O-NMR spectrum of the example PW-31 prepared in an embodiment of the present invention measuring in one day after prepared.

### DESCRIPTION OF THE PREFERRED EMBODIMENTS

For the ease of understanding the technical features, contents, advantages and effects of the present invention by those skilled in the art, detailed description of the embodiments and the appending drawings of the present invention will be described hereinafter.

The terms of “predetermined distance between electrodes”, “distance between two electrodes” or “electrode distance” refers to a distance between an anode electrolysis plate within an anode electrolysis tank and a cathode electrolysis plate within a cathode electrolysis tank of an electrolysis device. These terms may be replaced mutually.

The term “electrolysis reaction” represents a process of applying a current through a solution and inducing a redox reaction at the cathode (represents the cathode electrolysis plate herein after) and the anode (represents the anode electrolysis plate herein after). Wherein, an electron donating reaction (oxidation reaction) is generated at the cathode and an electron receiving reaction (reduction reaction) is generated at the anode.

The term “ion-exchange membrane” represents a thin film made of a polymer material having a selective permeability. The film has a specific pore size or a property which only allows specific molecules or ions to penetrate. The “ion-exchange membrane” is an ion-exchange membrane having an appropriate pore size selected for keeping the electrolysis reaction progress well and stable.

The terms of “small water molecule cluster” represents the water molecule cluster assembled by below 10 water molecules via the force of the hydrogen bonds between the molecules.

The terms of “Nuclear Magnetic Resonance (NMR)” and ¹⁷O-NMR represents a measuring method commonly used in physical, chemical and material field. The principle of the method is placing a sample under an external strong magnetic field so that the nuclear spins of the sample molecules may be rearranged because of the external magnetic field, and measuring the signal obtained when the nuclear spins returning back to the original form. The type of nuclear magnetic resonance used in the present invention is based on measuring the signal of oxygen atoms (O), wherein the sample should be a sample which replaces the ¹⁶O of the water molecule (H₂O) by ¹⁷O.

The term “half-width” represents a half value of the width of the signal obtained at about 0 ppm of a ¹⁷O-NMR spectrum. The half value represents the vibration frequency of water, which may further correspond to a size of water molecule clusters therein. Recently, the only way of measuring the size of water molecule clusters is NMR. The larger the half-width, the larger size of the water molecule clusters.

An aspect of the present invention involves adjusting two electrodes of an electrolysis device to a predetermined distance. The predetermined distance between the electrodes may significantly influence properties such as the pH value, ion concentration and size of water molecule clusters of the obtained nano super ion water and further influence the quality of the nano super ion water product of the present invention. In an embodiment of the present invention, the predetermined distance of the electrodes may be from 0.1 cm to 0.8 cm, preferably 0.1 cm to 0.5 cm, more preferably 0.1 cm to 0.2 cm, and most preferably 0.2 cm.

Subsequently, add pre-electrolysis water into an anode electrolysis tank. In an embodiment, the pre-electrolysis water may be tap water, well water, river water, mineral water, rainwater, mountain spring water, desalinated ocean water or filtered or deionized water thereof. Preferably, the pre-electrolysis water may be filtered tap water. In an embodiment, an anode electrolysis plate connected with a DC source is arranged in the anode electrolysis tank. In the embodiments of the present invention, the anode electrolysis tank is separated with the cathode electrolysis tank by an ion-exchange membrane.

Afterwards, add a carbonate solution into a cathode electrolysis tank. In an embodiment, the carbonate solution may be a solution of potassium carbonate, sodium carbonate or other alkali carbonates. Preferably, the carbonate solution is a potassium carbonate solution. In a preferable embodiment, the w/w concentration of the potassium carbonate solution/sodium carbonate solution is from 1% (w/w) to 10% (w/w). In an embodiment, a cathode electrolysis plate connected with a DC source is arranged in the cathode electrolysis tank. In the embodiments of the present invention, the cathode electrolysis tank is separated with the anode electrolysis tank by an ion-exchange membrane.

After finishing above steps, applying an electrolysis reaction to the pre-electrolysis water and the potassium carbonate solution separated by the ion-exchange membrane. In the embodiments of the present invention, the anode electrolysis tank and the cathode electrolysis tank are separated by the ion-exchange membrane, In an embodiment, the pore size of the ion-exchange membrane is from 0.001 μm to 0.01 μm, preferably from 0.001 μm to 0.005 μm, more preferably from 0.001 μm to 0.002 μm, and most preferably 0.0015 μm.

The electrolysis reaction is carried out by applying a voltage between 8 V to 15 V to the anode electrolysis plate connecting to a positive electrode of the DC source within the anode electrolysis tank containing the pre-electrolysis water and the cathode electrolysis plate connecting to a negative electrode of the DC source within the cathode electrolysis tank containing the carbonate solution.

In an embodiment, gas products such as carbon dioxide, carbon monoxide, and hydrogen gas are generated during electrolysis. In an embodiment, the gas products generated during electrolysis are extracted by a gas extraction device to prevent the gas products from re-dissolving into the water and changing the pH value and the component in the water, for instance, the carbon dioxide generated may re-dissolve and becomes carbonic acid.

In an embodiment, the electrolyzed alkali group ions from the carbonate in the cathode electrolysis tank are attracted from and moved to the anode electrolysis tank. Preferably, alkali group ions may penetrate the ion-exchange membrane and be accumulated in the anode electrolysis tank.

In an embodiment, the electrolysis reaction is terminated when the pre-electrolysis water within the anode electrolysis tank reaches a specific pH value. Preferably, the specific pH value may range between 8 to 14, more preferably 9 to 14, even more preferably 9.5 to 13.5 and most preferably 10 to 13.5.

In a preferable embodiment, a potassium carbonate/sodium carbonate solution is added into a cathode electrolysis tank, and pre-electrolysis water is added into an anode electrolysis tank to carry out an electrolysis reaction. The electrolysis reaction is terminated when the pH value of the pre-electrolysis water within the anode electrolysis tank reaches 10.5. At this moment, the solution in the anode electrolysis tank may be a solution containing 0.0017% (w/w) potassium/sodium ion (i.g. alkaline ionized water). In a more preferable embodiment, a potassium carbonate/sodium carbonate solution is added into a cathode electrolysis tank, and pre-electrolysis water is added into an anode electrolysis tank to carry out an electrolysis reaction. The electrolysis reaction is terminated when the pH value of the pre-electrolysis water within the anode electrolysis tank reaches 12.5. At this moment, the solution in the anode electrolysis tank may be a solution containing 0.17% (w/w) potassium/sodium ion (i.g. alkaline ionized water).

In an embodiment, collect nano super ion water product from the anode electrolysis tank and measure the half-width of the product by ¹⁷O-NMR to determine the corresponding size of water molecule clusters. In the embodiments of the present invention, the half-width may be a value between 45 Hz to 75 Hz, preferably 50 Hz to 70 Hz, more preferably 50 Hz to 60 Hz, and most preferably 45 Hz to 55 Hz.

Detailed descriptions of NMR spectrum results of the measured nano super ion water prepared by the embodiments of the present invention will be described below. The descriptions are merely for the ease of understanding the present invention by a person skilled in the art and are not intended to limit the present invention in any way.

In an example of the present invention, a sample PM-25 is the nano super ion water prepared by the method of the present invention. In particular, the sample PM-25 is a sample prepared at a condition as follows: the distance between two electrodes is 0.3 cm; the pore size of the ion-exchange membrane is 0.001 μm; the cathode electrolysis tank contains potassium carbonate; the voltage DC source applies a voltage of 13 V to the pre-electrolysis water. Further, the sample PM-31 is a sample prepared at a condition as follows: the distance between two electrodes is 0.35 cm; the pore size of the ion-exchange membrane is 0.0017 μm; the cathode electrolysis tank contains potassium carbonate; the voltage DC source applies a voltage of 10 V to the pre-electrolysis water.

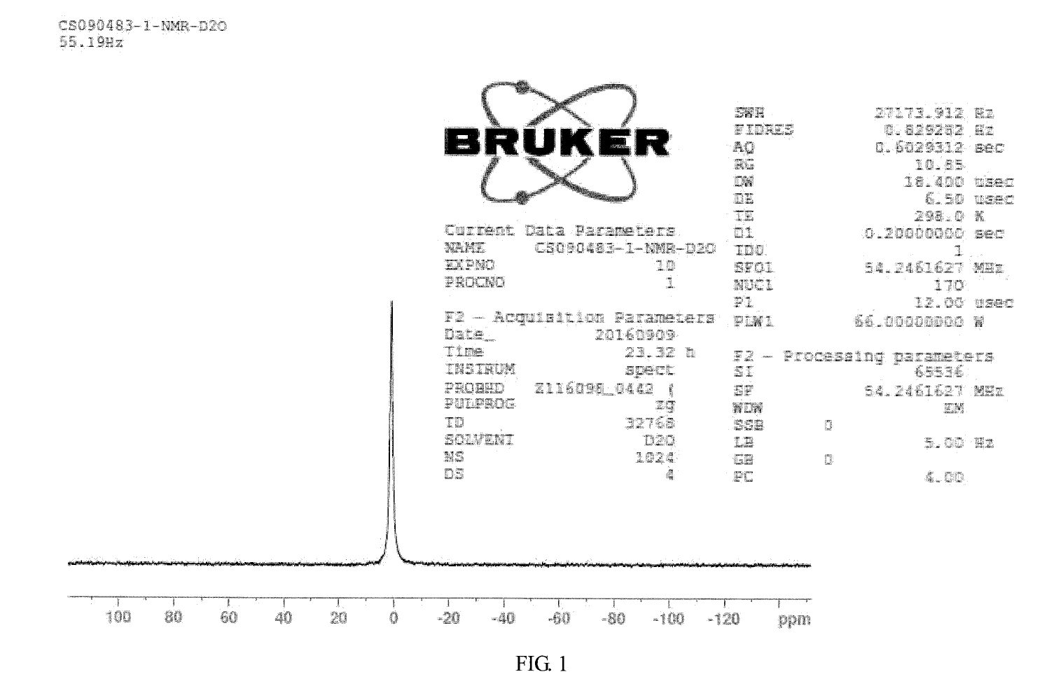

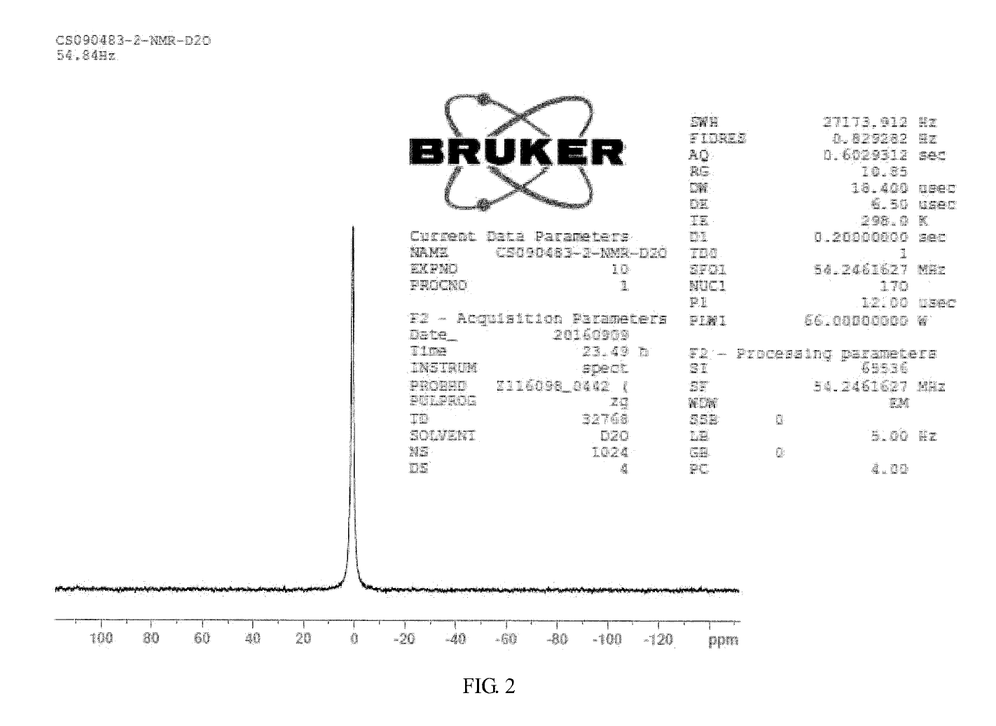

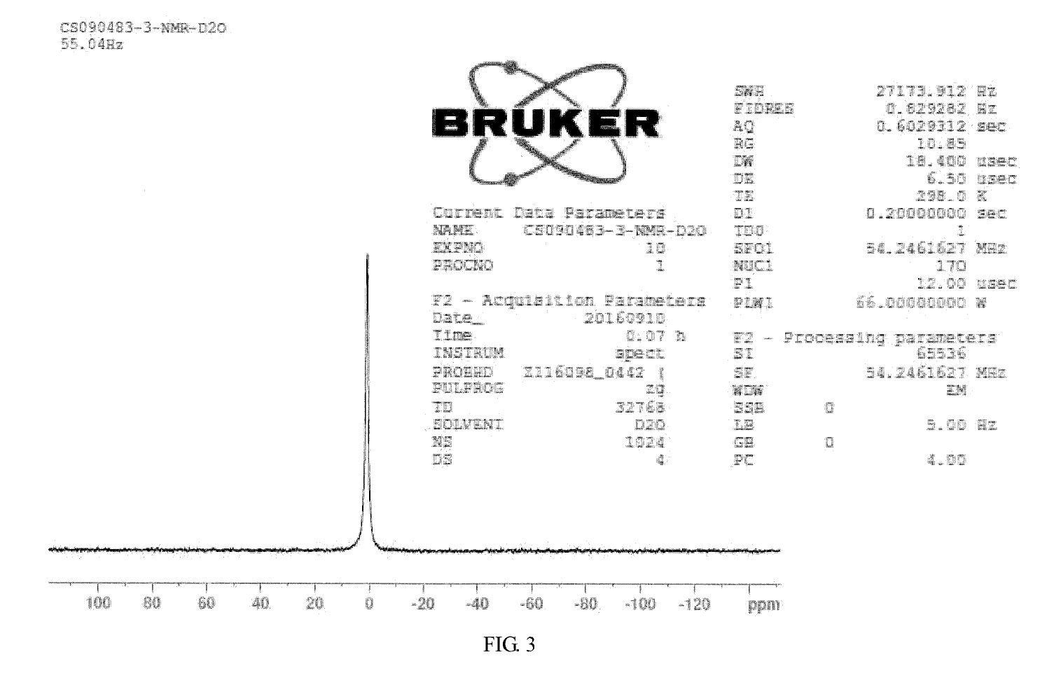

The samples of PM-25 and PM-31 in one day after preparation and the sample of PM-25 stored for 3 months after preparation are measured by ¹⁷O-NMR manufactured by Bruker Corporation (US) according to the General rules for superconducting pulse fourier transform nuclear magnetic resonance spectrometry JY/T007-1996. The result spectrums are shown in FIGS. 1 to 3, and the quantitative results thereof are shown in the following Table 1.

TABLE 1

| | | Corresponding Sample No | | | |
|---|---|---|---|---|---|
| Sample Serial Number | | of the present invention | | | |
| 2016090483-1 | | PW-25 (in 1 day) | | | |
| 2016090483-2 | | PW-25 (after 3 months) | | | |
| 2016090486-3 | | PW-31 (in 1 day) | | | |
| Sample Serial No. | Sample | Test Item | Unit | Result | Ref. |
| 2016090483-1 | Nano super ion water | Half-width | Hz | 55.19 | JY/T |
| 2016090483-2 | Nano super ion water | Half-width | Hz | 54.84 | 007- |
| 2016090483-3 | Nano super ion water | Half-width | Hz | 55.04 | 1996 |

As shown in Table 1, the nano super ion water prepared by the method of the present invention has a half-width between about 54 Hz to 56 Hz, and shown no significant changes after storing for 3 months.

The following Table 2 shows appropriate information excerpted from the website of United Nation Quality Detection

(www.unqdfenxi.com/news_content.php?id=405).

TABLE 2

| | | Number of water molecules |
|---|---|---|
| Water Source | Half-width (Hz) | in a water molecule cluster |
| Glacier Water | 63 | 7 |
| Normal Mineral water | 84 | 9 |
| Reverse osmosis water | 119 | 12 |
| Tap water | Over 110~130 | 14 |
| Spring (polluted) | 122 | 13 |
| Rain water | 119 | 12 |
| Distilled water | 118 | 12 |
| Well water | 105 | 11 |

According to Table 1 in combination with Table 2, it can be observed that the nano super ion water samples PM-25 and PM-31 may be water having small water molecule clusters that are formed of less than 7 water molecules. Further, the small water molecule clusters still do not aggregate as large water molecule clusters after storing for a period of time.

It is to be understood that the present invention is not limited to the contents described above. Any equivalent modifications, variations and enhancements can be made thereto by those skilled in the art without changing the essential characteristics or technical spirit of the present invention, the technical and protective scope of which is defined by the following claims.

What is claimed is:

1. A method of manufacturing a nano super ion water, comprising:
adjusting a distance of two electrodes of an electrolysis device to a predetermined distance;
adding pre-electrolysis water into an anode electrolysis tank;
adding a carbonate solution into a cathode electrolysis tank;
applying an electrolysis reaction to the pre-electrolysis water and the carbonate solution separated by an ion-exchange membrane; and
collecting the nano super ion water from the anode electrolysis tank.

2. The method as in claim 1, wherein the predetermined distance is from 0.1 cm to 0.8 cm.

3. The method as in claim 1, wherein a voltage used in the electrolysis reaction is from 8 V to 15 V.

4. The method as in claim 1, wherein the ion-exchange membrane has a pore size between 0.001 μm to 0.005 μm.

5. The method as in claim 1, further comprising extracting a gas product using a gas extraction device during the electrolysis reaction.

6. A nano super ion water, which is manufactured by the method of any one of claims 1 to 5.

7. The nano super ion water as in claim 6, wherein the pH value of the nano super ion water is from 8 to 14.

8. The nano super ion water as in claim 6, wherein the nano super ion water is a solution comprising 0.001% to 1.000% (w/w) of an alkali metal hydroxide.

9. The nano super ion water as in claim 6, wherein the nano super ion water comprises a water molecule cluster assembled by 4 to 13 water molecules.

10. The nano super ion water as in claim 6, wherein a half-width value of the nano super ion water measured by ¹⁷O-NMR is about 45 Hz to 70 Hz.
